(19) United States
(12) Patent Application Publication
(10) Pub. No.: US 2019/0041696 A1
(43) Pub. Date: Feb. 7, 2019

(54) OPTICAL MEMORY, BACKLIGHT UNIT INCLUDING THE SAME AND METHOD FOR MANUFACTURING BACKLIGHT UNIT

(71) Applicant: SAMSUNG DISPLAY CO., LTD,, YONGIN-SI (KR)

(72) Inventors: Do Hun Kim, Suwon-Si (KR); Young Min Park, Hwaseong-Si (KR); Taek Sun Shin, Yongin-Si (KR); Hyun Hyang Kim, Suwon-Si (KR); Ji Eun Nam, Seoul (KR)

(21) Appl. No.: 16/050,961

(22) Filed: Jul. 31, 2018

(30) Foreign Application Priority Data
Aug. 1, 2017 (KR) 10-2017-0097700

(51) Int. Cl. G02F 1/1335; F21V 8/00

(52) U.S. Cl. CPC G02F 1/133602; G02B 6/003; G02B 6/0036; G02B 6/0031

(57) ABSTRACT

A backlight unit includes a light guide plate that includes an upper surface, at least one side surface, and an inclined portion disposed at an edge between the upper surface and the at least one side surface, and an optical member that includes a protruding portion disposed on the inclined portion of the light guide plate.

### CROSS-REFERENCE TO RELATED APPLICATION

This application claims priority under 35 USC § 119 from, and the benefit of Korean Patent Application No. 102017-0097700, filed on Aug. 1, 2017 in the Korean Intellectual Property Office, the contents of which are herein incorporated by reference in their entirety.

### BACKGROUND

### 1. Technical Field

Embodiments of the present disclosure are directed to an optical member, a backlight unit including the same and a method for manufacturing the backlight unit.

### 2. Discussion of the Related Art

A liquid crystal display device receives light from a backlight unit and displays an image. Some backlight units include a light source and a light guide plate. The light guide plate receives light from the light source and guides a light propagation direction to be towards a display panel. A point light source such as an LED is generally used as a light source. However, in the case of a point light source, since light is emitted over a wide angular spread, the amount of light incident on the light guide plate decreases, and the amount of light incident on light guide plate may be insufficient to display an image. Light which is not incident on the light guide plate results in light leakage on the side of the light incident surface of the display device. In addition, if the intensity of light decreases in the light guide plate, the luminance of the opposite surface decreases.

### SUMMARY

Embodiments of the present disclosure can provide an optical member that can improve the light incidence efficiency and light collection efficiency of a light guide plate.

Embodiments of the present disclosure can also provide a light guide plate and a display device that includes an optical member that can improve the light incidence efficiency and light collection efficiency.

Embodiments of the present disclosure can also provide a method for manufacturing an optical member that can improve the light incidence efficiency and light collection efficiency of a light guide plate.

However, embodiments of the present disclosure are not restricted to those set forth herein. The above and other embodiments of the present disclosure will become more apparent to one of ordinary skill in the art to which the present disclosure pertains by referencing the detailed description of the present disclosure given below.

According to an embodiment of the present disclosure, there is provided a backlight unit, including: a light guide plate that includes an upper surface, at least one side surface, and an inclined portion disposed at an edge between the upper surface and the at least one side surface, and an optical member that includes a protruding portion disposed on the inclined portion of the light guide plate.

According to an embodiment of the present disclosure, there is provided an optical member, including: a base member, a first pattern disposed on a first surface of the base member, and a second pattern disposed on second surface of the base member that is opposite to the first surface, wherein the first pattern includes a protruding portion disposed adjacent to a side surface of the base member, wherein a thickness of the protruding portion is greater than or equal to the thickness of the flat portion, wherein the protruding portion has a triangular prism shape that extends in a first direction parallel to the side surface, wherein a cross section of the protruding portion becomes thinner with increasing distance from the side surface, and wherein the second pattern includes a plurality of prisms or lenticular shapes that extend in a second direction perpendicular to the first direction.

According to another embodiment of the present disclosure, there is provided an optical member, including: a base member, a first pattern disposed on a surface of the base member, and a second pattern disposed adjacent to the first pattern on the surface of the base member, wherein the first pattern includes a protruding portion disposed adjacent to a side surface of the base member, wherein the protruding portion has a triangular prism shape that extends in a first direction parallel to the side surface, wherein the second pattern includes a plurality of prisms or lenticular shapes that extend in a second direction perpendicular to the first direction, and wherein an area of the second pattern is larger than an area of the first pattern in a plan view.

According to an optical member according to an embodiment, it is possible to improve the light incidence efficiency and the light collection efficiency of a light guide plate.

### BRIEF DESCRIPTION OF THE DRAWINGS

FIG. 1 is an exploded perspective view of a display device according to an embodiment.

FIG. 2 is a perspective view of a light guide plate and an optical member according to an embodiment.

FIG. 3 is a plan view of a light guide plate and an optical member according to an embodiment.

FIG. 4 is a cross-sectional view taken along line IV-IV′ of FIG. 3.

FIG. 5 is a graph of results of measuring the light incidence efficiency using each light guide plate.

FIGS. 6A and 6B are graphs of results of measuring the reduction in light leakage using each light guide plate.

FIG. 7 is a photograph that shows the results of measuring the light emission angle using each light guide plate.

FIG. 8 is a graph of results of measuring the light emission angle using each light guide plate.

FIG. 9 is a perspective view of a light guide plate and an optical member according to another embodiment.

FIG. 10 is a cross-sectional view taken along line X-X′ of FIG. 9.

FIGS. 11 and 12 are cross-sectional views of a light guide plate and an optical member according to still another embodiment.

FIG. 13 is a flowchart of a method of manufacturing an optical member according to an embodiment of the present disclosure;

FIGS. 14 to 22 are cross-sectional views that illustrate a method of manufacturing a light guide plate that includes an optical member according to an embodiment of the present disclosure.

FIG. 23 is a flowchart of a method of manufacturing an optical member according to another embodiment of the present disclosure.

FIGS. 24 to 26 are cross-sectional views that illustrate a method of manufacturing an optical member according to another embodiment of the present disclosure.

### DETAILED DESCRIPTION OF EXEMPLARY EMBODIMENTS

Features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein.

Cases where elements or layers are referred to as being located “on” other elements or layers include all the cases where other layers or other elements are interposed directly on or between other elements. The same reference numerals may refer to the same constituent elements throughout the specification.

Hereinafter, embodiments will be described with reference to the accompanying drawings.

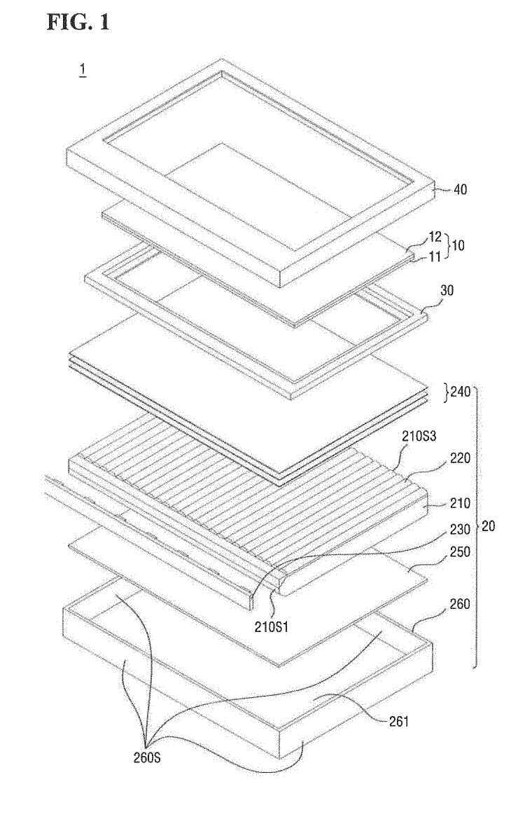

FIG. 1 is an exploded perspective view of a display device according to an embodiment.

Referring to FIG. 1, a display device 1 includes a display panel 10, a backlight unit 20 disposed below the display panel 10, a mold frame 30 disposed between the display panel 10 and the backlight unit 20 and a top chassis 40. Unless otherwise defined, as used herein, the terms “top” and “upper surface” refer to a display surface side with respect to the display panel 10, and “bottom” and “lower surface” refer to a side opposite to the display surface with respect to the display panel 10.

According to an embodiment, the display device 1 has a rectangular shape in a plan view and has a rectangular parallelepiped shape as a whole. The display device 1 may be a flat display device 1 or a curved display device 1.

According to an embodiment, the display panel 10 is, for example, a liquid crystal display panel 10 that displays an image. In a following embodiment, a flat panel display device 1 that includes the liquid crystal display panel 10 as the display panel 10 will be described, but embodiments of the present disclosure are not limited thereto. For example, the display panel may be an electro wetting display panel, an electrophoretic display panel, or a micro electro mechanical system (MEMS) display panel.

According to an embodiment, the display panel 10 includes a first substrate 11, a second substrate 12 that faces the first substrate 11 and a liquid crystal layer interposed between the first substrate 11 and the second substrate 12. The first substrate 11 and the second substrate 12 overlap each other.

According to an embodiment, a backlight unit 20 is disposed below the display panel 10. The backlight unit 20 provides light to the display panel 10. That is, the display panel 10 receives light from the backlight unit 20 and displays an image.

According to an embodiment, the backlight unit 20 includes a light guide plate 210, an optical member 220, a light source 230, an optical film 240, a reflective member 250 and a receiving member 260.

According to an embodiment, the receiving member 260 includes a bottom portion 261. and a sidewall 260S that extends up from the bottom portion 261. That is, the receiving member 260 has a box shape that encloses a receiving space formed by the bottom portion 261 and the sidewall 260S.

According to an embodiment, the light guide plate 210, the optical member 220, the light source 230, the reflective member 250, etc., are accommodated in the receiving space of the receiving member 260.

According to an embodiment, the light source 230 provides light to at least one side surface 2108 of the light guide plate 210. That is, the light source 230 is disposed adjacent to the at least one side surface 210S of the light guide plate 210. Although the drawing shows the light source 230 as being disposed on a side surface 210S1 adjacent to a long side of the light guide plate 210, embodiments of the present disclosure are not limited thereto. In an embodiment of FIG. 1, a long side surface of the light guide plate 210 is a light incidence surface adjacent to the light source 230, denoted by ‘210S1’ in the drawing, on which light of the light source is directly incident, and the other, opposite, long side is an opposite surface, denoted by ‘210S3’ in the drawing.

According to an embodiment, the light source 230 includes a plurality of point light sources or linear light sources. An exemplary point light source is a light emitting diode (LED) light source. The plurality of light sources 230 are mounted on a printed circuit board.

According to an embodiment, the light source 230 is arranged so that the center of the light source 230 is aligned with the center of the light guide plate 210. That is, the light source 230 is aligned with the light incidence surface 210S1 of the light guide plate 210 so that light emitted from the light source 230 is incident on as much of the light incidence surface 210S1 as possible.

According to an embodiment, the light source 230 is separated by about 0.1 mm to 0.3 mm from the light incidence surface 210S1 of the light guide plate 210. When a distance between the light source 230 and the light incidence surface 210S1 is greater than 0.1 mm, it is possible to prevent the light guide plate 210 from being damaged by heat generated from the light source 230. When the distance between the light source 230 and the light incidence surface 210S1 is less than 0.3 mm, it is possible to effectively secure light emitted from the light source 230 that is incident into the light guide plate 210, while preventing deterioration of the light guide plate 210.

According to an embodiment, the light guide plate 210 guides a light propagation path. Specifically, light emitted from the light source 230 is incident onto the light incidence surface 210S1 of the light guide plate 210, propagates toward the opposite surface 210S3 and is totally reflected inside the light guide plate 210.

According to an embodiment, the light guide plate 210 includes an inorganic material. For example, the light guide plate 210 may be made of glass, but is not limited thereto. For example, the light guide plate 210 may be made of a polymer resin such as polymethyl methacrylate (PMMA), polycarbonate (PC), acrylic resin, etc.

According to an embodiment, the optical member 220 is disposed on the upper surface of the light guide plate 210. The optical member 220 is attached to the upper surface of the light guide plate 210. The optical member 220 enhances the light incidence efficiency, which is the amount of light incident on the light guide plate 210 with respect to the light emitted from the light source 230, and guides the light incident on the light incidence surface 210S1 toward the opposite surface 210S3 to enhance the light intensity. The optical member 220 will be described in detail below.

According to an embodiment, at least one optical film 240 is disposed between the display panel 10 and the optical member 220, One or a plurality of optical films 240 can be accommodated in the mold frame 30.

The optical film 240 may be a prism film, a diffusion film, a micro lens film, a polarizing film, a reflective polarizing film, a retardation film, etc. A plurality of optical films 240 can be used, which may include optical films 240 of the same type or of different types, and to the optical films 249 overlap each other.

According to an embodiment, the reflective member 250 is disposed on the lower surface of the light guide plate 210. The reflective member 250 includes a reflective film or reflective coating layer. The reflective member 250 reflects light incident onto a lower surface 210b of the light guide plate 210 into the light guide plate 210 again.

According to an embodiment, the mold frame 30 is disposed between the display panel 10 and the backlight unit 20. That is, the mold frame 30 comes into contact with a rim portion of the lower surface of the display panel 10, and can support the display panel 10. The rim portion of the lower surface of the display panel 10 is a non-display area of the display panel 10. That is, at least a portion of the mold frame 30 overlaps a non-display area of the display panel 10. However, embodiments of the present disclosure are not limited thereto, and in some embodiments, the mold frame 30 is omitted, In that case, the display panel 10 is supported by the receiving member 260 or a housing, and is fixed by an adhesive member between the receiving member 260 or housing and the display panel 10.

According to an embodiment, the top chassis 40 covers the rim of the display panel 10 and surrounds the side surfaces of the display panel 10 and the backlight unit 20, in other words, the top chassis 40 is disposed on the top of the display panel 10 to cover the non-display area of the display panel 10. The top chassis 40 may be omitted.

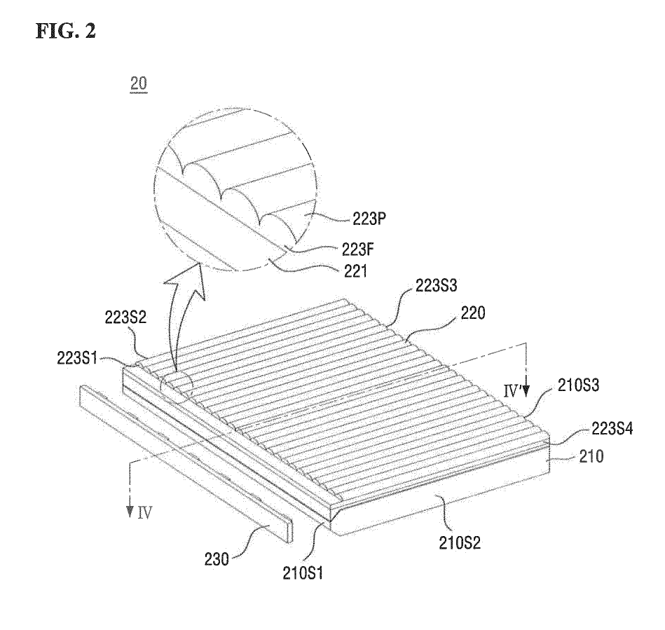

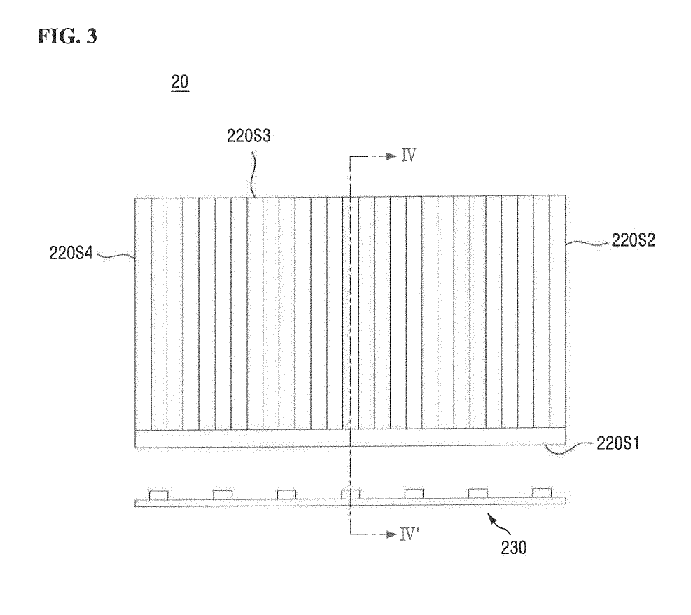

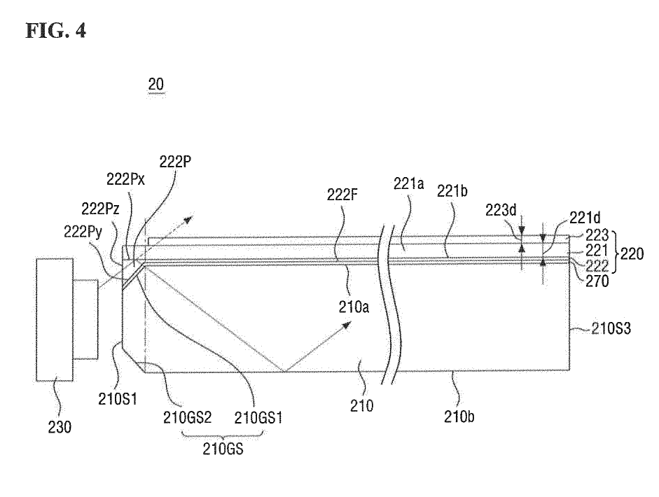

FIG. 2 is a perspective view of a light guide plate and an optical member according to an embodiment. FIG. 3 is a plan view of a light guide plate and an optical member according to an embodiment. FIG. 4 is a cross-sectional view taken along line IV-IV′ of FIG. 3.

Referring to FIGS. 2 to 4, according to an embodiment, the light guide plate 210 has a generally polygonal columnar shape. Illustratively, the light guide plate 210 has a shape similar to a hexahedron that includes an upper surface 210a, a lower surface 210b and four side surfaces 210S, each having a rectangular shape in a plan view, and further includes inclined portions 210GS1 and 210GS2 between the upper surface 210a and the side surface 210S and between the lower surface 210b and the side surface 210S. In an exemplary embodiment, the light guide plate 210 includes, as shown in FIG. 4, a first inclined portion 210GS1 formed between the upper surface 210a and the light incidence surface 210S1, and a second inclined portion 210GS2 formed between the lower surface 210b and the light incidence surface 210S2. In other words, a chamfer is formed at the edge of the light incidence surface 210S1 of the light guide plate 210. The edge of the light guide plate 210 can be prevented from being damaged by the chamfer. The inclined surface 210GS of the light guide plate 210 is formed between the upper surface 210a and the lower surface 210b and the other side surfaces 210S2, 210S3 and 210S4 of the light guide plate 210. In the following description, for convenience of explanation, if it is necessary to distinguish the four side surfaces, they are respectively referred to as ‘S1’, ‘S2’, ‘S3’ and ‘S4.’ If it is not necessary to distinguish the side surfaces, they are collectively referred to as ‘S’.

According to an embodiment, the optical member 220 is disposed on the upper surface 210a of the light guide plate 210.

According to an embodiment, the optical member 220 includes a base member 221, a first pattern 222 and a second pattern 223.

According to an embodiment, the base member 221 supports the first pattern 222 and the second pattern 223.

According to an embodiment, the base member 221 overlaps and covers the entire light guide plate 210 in a plan view. In other words, each side surface 221S of the base member 221 is substantially aligned with a corresponding side surface 210S of the light guide plate 210. However, embodiments of the present disclosure are not limited thereto, and the base member 221 may be smaller than the light guide plate 210. In this case, one side surface 210S of the light guide plate 210 includes a region that protrudes outward from one side surface 221S of the base member 221 and is externally exposed.

According to an embodiment, the base member 221 is formed of a transparent material such as PET or acryl, and a thickness 221d of the base member 221 is in a range of about 70 μm to about 90 μm, or from about 75 μm to about 85 μm, or about 80 μm. When the thickness 221d of the base member 221 is greater than or equal to 70 μm, the base member 221 is sufficiently hard to support the first pattern 222 and the second pattern 223, When the thickness 221d of the base member 221 is less than or equal to about 90 μm, the influence on an optical path is reduced. in accordance with the thickness reduction of the display device 1.

According to an embodiment, first pattern 222 is disposed on the lower surface 221b of the base member 221, i.e., between the base member 221 and the light guide plate 210. The first pattern 222 overlaps and covers the base member 221. That is, each side surface 222S of the first pattern 222 is substantially aligned with a corresponding side surface 221S of the base member 221, In other words, the first pattern 222 is disposed to overlap and cover the entire upper surface 210a of the light guide plate 210 in a plan view.

According to an embodiment, the first pattern 222 may include a flat portion 222F and a protruding portion 222P that extends from the fiat portion 222F. The protruding portion 222P is integrally formed with the flat portion 222F and protrudes in a thickness direction from the flat portion 222F. The flat portion 222F of the first pattern 222 overlaps the upper surface 210a of the light guide plate 210 and the protruding portion 222P of the first pattern 222 overlaps the first inclined portion 210GS1 of the light guide plate 210. In a plan view, the area of the flat portion 222F is larger than the area of the protruding portion 222P.

According to an embodiment, the flat portion 222F has a thickness that is less than that of the protruding portion 222P. The protruding portion 222P and the flat portion 222F are integrally formed. Since the protruding portion 222P has a relatively small area, the protruding portion 222P has a limited contribution to a bonding force with the base member 221. However, since the fiat portion 222F has a large area and is attached onto the base member 221, the protruding portion 222P can be coupled to the base member 221 with a sufficient bonding force through the flat portion 222F.

According to an embodiment, the protruding portion 222P has a triangular prism shape with a triangular cross section. That is, the protruding portion 222P has a triangular prism shape that extends continuously from the second side surface 210S2 to the fourth side surface 210S4 of the light guide plate 210, in other words, the protruding portion 222P has a triangular prism shape that extends in a direction perpendicular to a direction from the light incidence surface 210S1 toward the opposite surface 210S3.

According to an embodiment, the protruding portion 222P has a triangular prism shape that includes a flat surface 222Px, an inclined surface 222Py and a side surface 222Pz. Specifically, the fiat surface 222Px extends in a horizontal direction from the flat portion 222F, the inclined surface 222Py is inclined downward from the flat portion 222F and the side surface 222Pz connects the flat surface 222Px and the inclined surface 222Py. Here, the inclined surface 222Py corresponds to the first inclined portion 210GS1, and the flat surface 222Px and the side surface 222Pz meet vertically.

More specifically, according to an embodiment, the inclined surface 222Py of the protruding portion 222P has substantially the same area with the same inclination as the first inclined portion 210GS1 of the light guide plate 210. The side surface 222Pz of the protruding portion 222P is aligned on a plane parallel to the light incidence surface 210S1. In an exemplary embodiment, the side surface 222Pz is aligned substantially on the same plane as the light incidence surface 210S1. In this case, the light incidence surface 210S1 extends in the thickness direction to the side surface 222Pz.

According to an embodiment, the flat surface 222Px of the protruding portion 222P is aligned substantially on the same plane as the upper surface 210a of the light guide plate 210. The upper surface 210a of the light guide plate 210 extends in the longitudinal direction of the light guide plate 210 to the flat surface 222Px of the protruding portion 222P. In other words, the triangular prism shaped protruding portion 222P combines with the first inclined portion. 210GS1 of the light guide plate 210 to fill the chamfer at the edge of the light guide plate 210. Accordingly, the light guide plate 210 can perform an optical function substantially similar to that of the light guide plate having a vertical edge on the light incidence surface. As a result, an effective area of the light incidence surface of the light guide plate 210 can be increased.

According to an embodiment, the first pattern 222 is formed of a material having a refractive index similar to the refractive index of the light guide plate 210. When the first pattern 222 and the light guide plate 210 have similar refractive indices, since an interface between the first pattern 222 and the light guide plate 210 does not form an optical interface, the first pattern 222 and the light guide plate perform substantially the same light guiding function.

According to an embodiment, the first pattern 222 complements the first inclined portion 210GS1 of the light guide plate 210. That is, as the light incidence surface 210S1 of the light guide plate 210 is extended by the side surface 222Pz of the protruding portion 222P of the first pattern 222, the amount of light incident into the light guide plate 210 increases. In particular, in the absence of the first pattern 222, a portion of the light emitted from the light source 230 cannot be incident into the light guide plate 210, but leaks out and can be visually recognized as such in the display device 1. However, when the first pattern 222 and the light guide plate 210 are coupled to each other, the light incident surface 210S1 of the light guide plate 210 is extended by the side surface 222Pz of the protruding portion 222P of the first pattern 222 and increases the light incidence area. That is, after light emitted from the light source 230 is incident on the first pattern 222, it is totally reflected and propagates into the light guide plate 210 through the first inclined portion 210GS of the light guide plate 210. As a result, the amount of light incident into the light guide plate 210 increases, and light leakage is reduced.

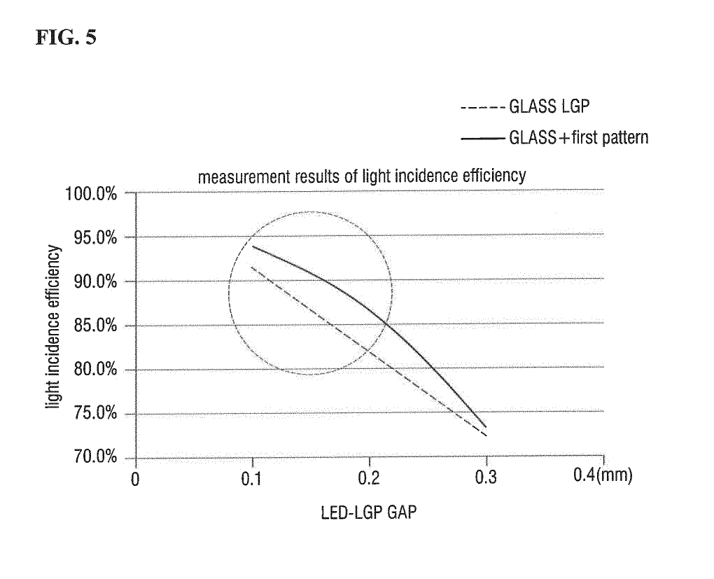

According to an embodiment, to experimentally confirm the improvement of the light incidence efficiency and the reduction of light leakage by the first pattern 222, a glass light guide plate 210 having a thickness of 1.1 mm that includes the first inclined portion 210GS1 and the second inclined portion 210GS2 formed between the light incidence surface 210S1 and the upper surface 210a and the lower surface 210b was prepared. In a comparative example, no first pattern 222 was disposed on the light guide plate 210. In another example according to an embodiment, the first pattern 222 corresponding to the first inclined portion 210GS1 of the light guide plate 210 was disposed on the light guide plate 210. FIG. 5 is a graph showing the results of measuring the light incidence efficiency using each light guide plate. Referring to FIG. 5, when the distance between the light source 230 and the light guide plate 210 is from 0.1 mm to 0.3 mm, the light incidence efficiency in the light guide plate 210 having the first pattern 222 is higher. Specifically, the light incidence efficiency in the light guide plate 210 having the first pattern 222 increases by an average of 2.7% and a maximum of 5.1%, That is, it can be seen that light incidence efficiency is higher in the light guide plate 210 that includes the first pattern 222, according to an embodiment of the present disclosure.

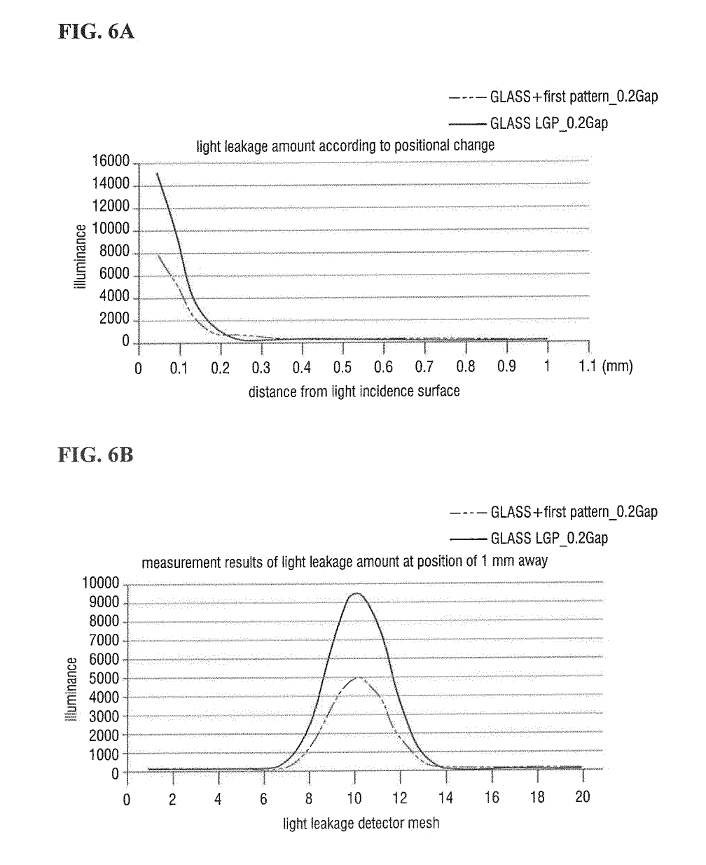

According to an embodiment, when the distance between the light guide plate 210 and the light source 230 is 0.2 mm, the amount of light leakage from the light incidence surface 210S1 to the opposite surface 210S3 of the light guide plate 210 due to a positional change was measured and shown in FIGS. 6A and 6B. Referring to FIG. 6A, when the first pattern 222 is disposed, it can he seen that the amount of light leakage decreases as a function of position from the light incidence surface 210S1 to the opposite surface 210S3.

Specifically, according to an embodiment, referring to FIG, 613, as a result of measuring the amount of light leakage at a position 1 mm away from the light incidence surface 210S1 toward the opposite surface of the light guide plate 210, the amount of light leakage when the first pattern 222 is disposed was reduced by about 52% as compared with when no first pattern 222 is disposed. That is, it can be seen that light leakage is reduced in the light guide plate 210 that includes the first pattern 222, according to an embodiment of the present disclosure.

Referring again to FIGS. 2 to 4, according to an embodiment, the second pattern 223 is disposed on the upper surface 221a of the base member 221, i.e., a surface opposite to the lower surface 222b on which the first pattern 222 is disposed.

According to an embodiment, the second pattern 223 can improve the light collection efficiency of the light guide plate 210. That is, the second pattern 223 guides light incident into the light guide plate 210 to propagate straight toward the opposite surface 210S3. Specifically, the second pattern 223 refracts light propagating toward the side surfaces 210S2 and 210S4 adjacent to the opposite surface 210S3 to propagate toward the opposite surface 210S3.

According to an embodiment, the second pattern 223 is separated from the light incidence surface 210S1 of the light guide plate 210 by a predetermined distance. Specifically, a first side surface 223S1 of the second pattern 223 is positioned toward the opposite surface 210S3 by a distance of about 1 mm to 3 mm, or about 1 mm to 2 mm, from the light incidence surface 210S1. However, embodiments of the present disclosure are not limited thereto, and the separation distance may vary. The first side surface 223S1 of the second pattern 223 and the light incidence surface 210S1 of the light guide plate 210 are substantially aligned. Although the drawing shows that the first side surface 223S1 of the second pattern 223 is positioned inward from the boundary between the flat portion 222F and the protruding portion 222P of the first pattern 222, embodiments of the present disclosure are not limited thereto, and the first side surface 223S1 may be aligned with the boundary or positioned outward from the boundary.

In addition, according to an embodiment, the remaining side surfaces 223S2, 223S3 and 223S4 of the second pattern 223 are substantially aligned with the remaining side surfaces, i.e. the opposite surface 210S3 and the side surfaces 210S2 and 210S4 other than the light incidence surface 210S1, of the light guide plate 210.

According to an embodiment, the second pattern 223 includes a base portion 223F and a pattern portion 223P that protrudes from the base portion 223F. The base portion 223F is a region between the pattern portion 223P and the base member 221 where no pattern is formed. The base portion 223F supports the pattern portion 223P and allows the second pattern 223 to be sufficiently coupled with the base member 221.

According to an embodiment, pattern portion 223P is where a pattern is formed. The pattern portion 223P continuously extends from the light incidence surface 210S1 toward the opposite surface 210S3 in a plan view. That is, the extending direction of the pattern portion 223P of the second pattern 223 is substantially perpendicular to the extending direction of the protruding portion 222P of the first pattern 222.

In an exemplary embodiment, the pattern portion 223P includes a plurality of lenticular shapes, each having a semicircular cross section and that continuously extend from the light incidence surface 210S1 toward the opposite surface 210S3. However, embodiments of the present disclosure are not limited thereto, and the pattern portion 223P may include a plurality of prism shapes that each have a triangular cross section.

According to an embodiment, the cross-sectional shape of the pattern portion 223P is constant along an extended straight line, but embodiments are not limited thereto.

According to an embodiment, a thickness 223d of the second pattern 223 is from about 18 μm to about 25 μm. When the thickness 223d of the second pattern 223 is less than about 25, it is suitable for use with a thin. optical member 220 and avoids excessive material costs. When the thickness 223d of the second pattern 223 is greater than about 18 μm, the height of the pattern portion 223P can be maintained.

According to an embodiment, the pitch of the pattern portion 223P of the second pattern 223 is from about 30 μm to about 50 μm. When the pitch of the pattern portion 223P is less than about 50, a second pattern 223 can be formed that has a clear and sharp pattern shape that efficiently collects light. When the pitch of the pattern portion 223P is greater than about 30 μm, it is sufficiently durable to maintain the shape of the pattern portion 223P.

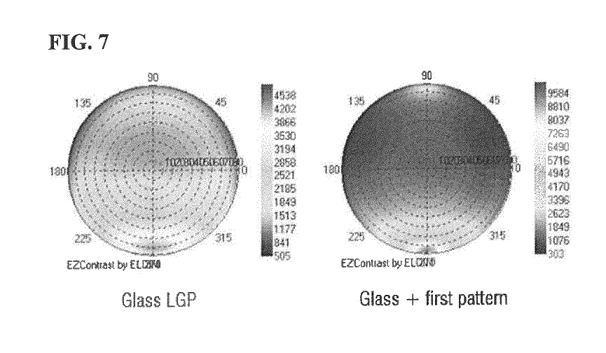

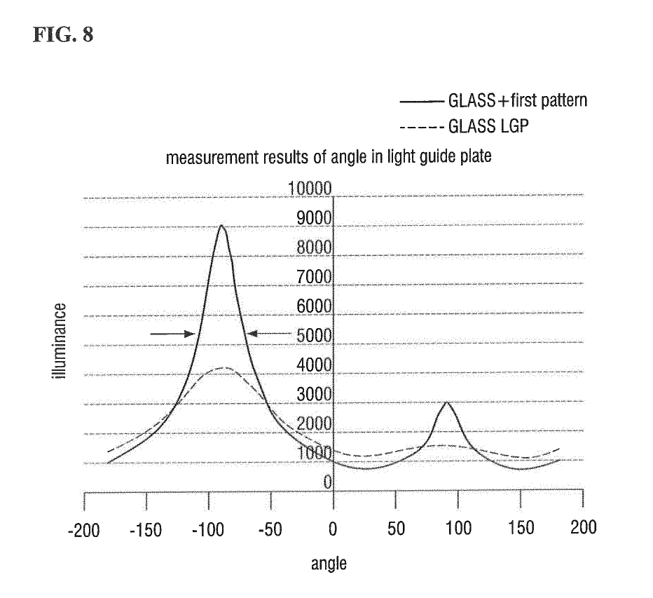

According to an embodiment, to experimentally confirm light collection of the second pattern 223, two light guide plates 210 formed of glass were prepared. In a comparative example, no second optical pattern was disposed on the light guide plate. In an embodiment, the second pattern 223 with pattern portion 223P having a thickness of about 22 μm and a pitch of about 40 μm was disposed on the light guide plate 210. FIGS. 7 and 8 are respectively a photograph and a graph showing results of measuring a light emission angle using each light guide plate. Referring to FIGS. 7 and 8, when a light guide plate 210 has no second pattern 223 disposed thereon, the light emission angle is wide, whereas when the light guide plate 210 has a second pattern 223 disposed thereon, the light emission angle is narrow. That is, when the light guide plate 210 has the second pattern 223 disposed thereon, the light collection function is improved, and as a result, the luminance of the entire display device 1 can be increased.

Referring again to FIGS. 2 to 4, according to an embodiment, an adhesive member 270 is interposed between the optical member 220 and the light guide plate 210. The upper surface of the adhesive member 270 is coupled with the lower surface of the optical member 220 and the lower surface of the adhesive member 270 is in contact with the upper surface 210a of the light guide plate 210 or the first inclined portion 210GS1. The adhesive member 270 contacts not only the flat portion 222F of the first pattern 222 of the optical member 220 but also the protruding portion 222P. The optical member 220 and the light guide plate 210 are coupled through the adhesive member 270.

According to an embodiment, the adhesive member 270 is a transparent adhesive member such as an optical transparent adhesive (OCA), an optical transparent resin (OCR), etc., but embodiments are not limited thereto.

According to an embodiment, the refractive index of the adhesive member 270 is lower than the refractive index of the light guide plate 210. In this case, the light guide plate 210 and the adhesive member 270 form an optical interface, so that total internal reflection occurs inside the light guiding plate 210.

According to an embodiment, a difference between the refractive index of the light guide plate 210 and the refractive index of the adhesive member 270 is greater than or equal to 0.2. When the difference between the refractive indices of the adhesive member 270 and the light guide plate 210 is greater than 0.2, sufficient total internal reflection from the upper surface 210a of the light guide plate 210 can be achieved. The upper limit of the difference between the refractive indices of the light guide plate 210 and the adhesive member 270 is not limited, but is typically less than or equal to 1, based on typical refractive indices of the light guide plate 210 and the adhesive member 270.

According to an embodiment, the refractive index of the adhesive member 270 is in a range from about 1.2 to about 1.4, or a range from about 1.2 to about 1.3. When the refractive index of the adhesive member 270 is greater than or equal to 1.2, excessive manufacturing costs increases of the adhesive member 270 can be prevented. Further, when the refractive index of the adhesive member 270 is less than or equal to 1.4, a critical angle of total internal reflection of the upper surface 210a of the light guide plate 210 can be reduced.

According to an embodiment, as described above, in light guide plate 210 with optical member 220, the first inclined portion 2100S1 on the side of the light incidence surface 210S1 of the light guide plate 210 is compensated by the first pattern 222, which improves light incidence efficiency and reduces light leakage. In addition, the light collection efficiency can be improved by the second pattern 223.

Hereinafter, other embodiments of a light guide plate and an optical member will be described. In the following embodiments, descriptions of the same or similar components as those of previously described embodiments will be omitted or simplified, and differences thereof will be mainly described.

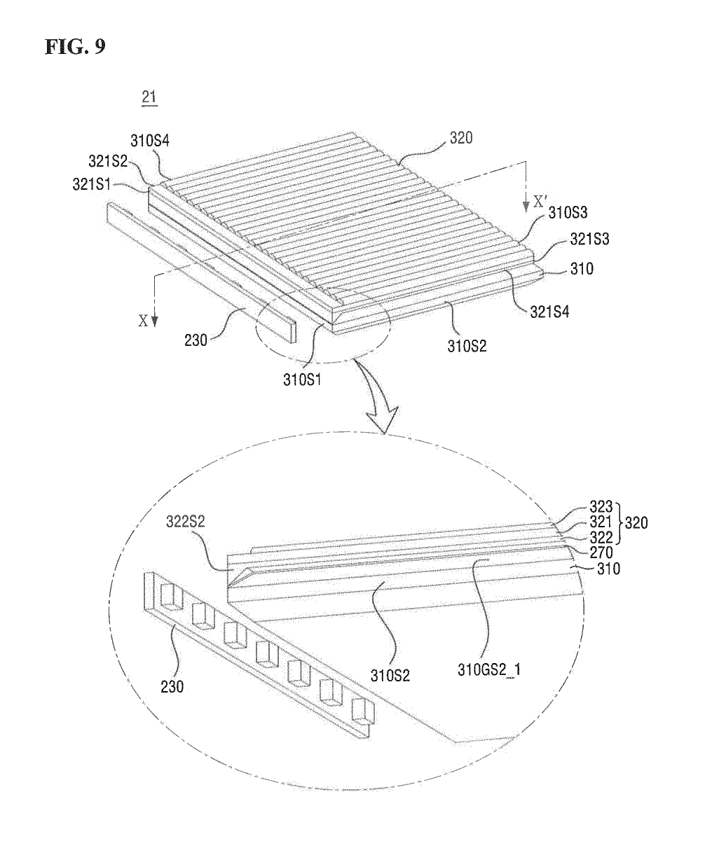

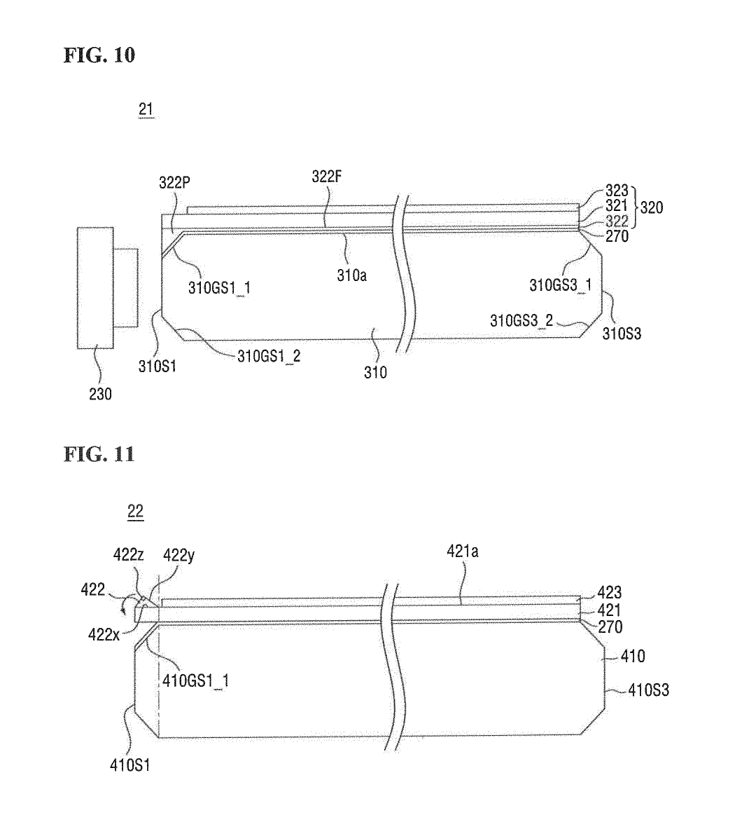

FIG. 9 is a perspective view of a light guide plate and an optical member according to another embodiment. FIG. 10 is a cross-sectional view taken along line X-X′ of FIG. 9.

Referring to FIGS. 9 and 10, according to an embodiment, an inclined portion 310GS is formed on each edge of a light guide plate 310 of a backlight unit 21. That is, as shown in FIG. 9, the light guide plate 310 further includes an inclined portion 310GS between an upper surface 310a and each of side surfaces 310S1, 310S2, 310S3 and 310S4 and between a lower surface 310b and each of the side surfaces 310S1, 310S2, 310S3 and 310S4. In other words, it is possible to effectively prevent the edges of the light guide plate from being damaged by forming chambers on all edges of the light guide plate 310.

According to an embodiment, an optical member 320 includes a base member 321, a first pattern 322 and a second pattern 323. The base member 321 overlaps the chambers on both side surfaces 310S2 and 310S4 and the upper surface 310a of the light guide plate 310 in a plan view. That is, side surfaces 321S1, 321S2, and 321S4 of the base member 321 are, respectively, substantially aligned on the same planes as the light incidence surface 310S1 and both side surfaces 310S2 and 310S4 of the light guide plate 310. On the other hand, side surface 321S3 of the base member 321 is disposed inward from the opposite surface 310S3 of the light guide plate 310 by a predetermined distance. In other words, in a plan view, the base member 321 overlaps inclined portions 310GS_1, 310GS2_1 and 310GS4_1, light incidence surface 310S1, and both side surfaces 310S2 and 310S4, but does not overlap an inclined portion 310GS3_1 on the opposite surface 310S3. However, embodiments of the present disclosure are not limited thereto, and in other embodiments, the base member 321 overlaps the inclined portion 310S3_1 on the side of the opposite surface 310S3.

Similar to the base member 321, according to an embodiment, a first pattern 322 is disposed that overlaps the upper surface 311a of the light guide plate 310, inclined portions 310GS1_1, 310GS2_1 and 310GS4_1, light incidence surface 310S1, and both side surfaces 310S2 and 310S4, but does not overlap the inclined portion 310S3_1 on the opposite surface 310S3.

According to an embodiment, the first pattern includes a flat portion 322F and a protruding portion 322P that overlaps and covers the first inclined portions 310GS1_1. That is, the protruding portion 322P is not disposed over the other inclined portions 310GS2_1, 310GS3_1 and 310GS4_1. That is, the other inclined portions 310GS2_1, 310GS3_1 and 310GS4_1, but not the first inclined portion 310GS1_1, overlap the base member 321 and the flat portion 322F, but do not overlap the protruding portion 322P. In this case, an empty space is formed between the inclined portions 310GS2_1, 310GS3_1 and 310G54_1 and the flat portion 322F. However, embodiments of the present disclosure are not limited thereto, and in other embodiments, the protruding portions overlap the inclined portions 310S2_1 and 310S4_1 on both side surfaces 310S2 and 310S4 and the inclined portion 310S3_1 on the opposite surface 310S3.

According to an embodiment, the side surfaces 310S2 and 310S4 on both short sides of the light guide plate 310 are, respectively, substantially aligned on the same plane as the side surfaces 322S2 and 322S4 of the first pattern 322. In this case, as described above, an empty space is formed between the lower surface 322b of the first pattern 322 and the inclined portions 310GS2_1 and 310G4_1 on both short side surfaces 310S2 and 310S4 of the light guide plate 310. However, embodiments of the present disclosure are not limited thereto, and in other embodiments the first pattern 322 is disposed only over the edge of the upper surface 310a of the light guide plate 310, and does not overlap the inclined portions 310GS2_1 and 310G4_1 on both short sides.

According to an embodiment of the present disclosure, the first pattern 322 fills the chamfer corresponding to the first inclined portion 310GS1_1 of the light guide plate 310.

Accordingly, the light incidence surface of the light guide plate 310 has a substantially greater area, which improves light incidence efficiency and reduces light leakage.

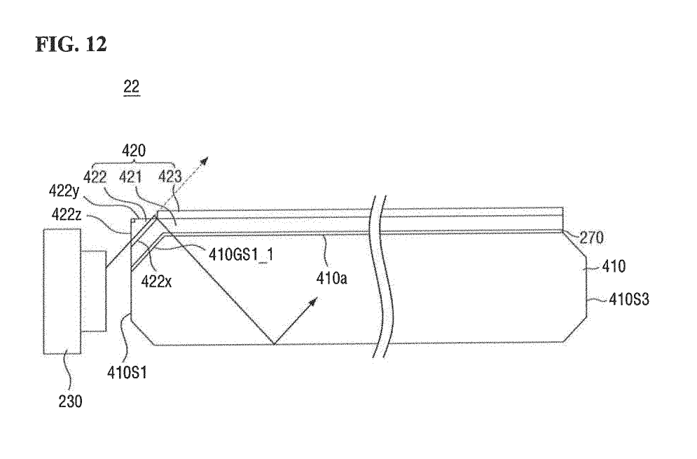

FIGS. 11 and 12 are cross-sectional views of a light guide plate and an optical member according to still another embodiment.

Referring to FIGS. 11 and 12, according to an embodiment, a first pattern 422 and a second pattern 423 of an optical member 420 of a backlight unit 22 are disposed on the same plane. That is, both the first pattern 422 and the second pattern 423 are disposed on an upper surface 421a of a base member 421.

According to an embodiment, the first pattern 422 includes only protruding portions. The flat portion 222F of the first pattern 222 according to embodiments of FIGS. 2 to 4 corresponds to the second pattern 423 according to embodiments of FIGS. 11 to 12. That is, the first pattern 422 and the second pattern 423 are integrally connected to each other. However, embodiments of the present disclosure are not limited thereto, and in other embodiments, the first pattern and the second pattern are spaced apart from each other by a predetermined distance. The boundary between the first pattern 422 and the second pattern 423 is substantially aligned with a boundary between a first inclined portion 410GS1_1 and an upper surface 410a of a light guide plate 410.

According to an embodiment, the extending direction of the first pattern 422 is substantially perpendicular to the extending direction of the second pattern 423, as illustrated in FIGS. 11 and 12.

According to an embodiment, the second pattern 423 has a greater area than the first pattern 422 in a plan view. As a result, the second pattern 423 can help couple the relatively smaller first pattern 422 to the base member 421 with a sufficient bonding force.

According to an embodiment, the first pattern 422 includes a flat surface 422x in contact with the base member 421, an first inclined surface 422y inclined upward from the base member 421 and a second inclined surface 422z that connects the first inclined surface 422y to the flat surface 422x. The first inclined surface 422y and the second inclined surface 422z form a right angle. That is, the first pattern 422 has a triangular prism shape whose cross section is a right triangle.

According to an embodiment, the flat base member 421 can be inclined downward along the first inclined portion 410GS1_1 of the light guide plate 410 while being coupled to the upper surface 410a and the first inclined portion 410GS1_1 of the light guide plate 410. As a result, the first inclined surface 422y of the first pattern 422 can be aligned parallel to the upper surface 410a of the light guide plate 410, and the second inclined surface 422z of the first pattern 422 can be aligned parallel to the light incidence surface 410S1 of the light guide plate 410. In an embodiment, the second inclined surfaces 422z of the first pattern 422 are aligned on substantially the same plane as the light incidence surface 410S1.

Similar to the first pattern 222 according to an embodiment of the present disclosure, the first pattern 422 according to another embodiment fills a chamfer corresponding to the first inclined portion 410GS1_1 to enlarge the area of the light incidence surface 410S1 of the light guide plate 410 Specifically, light emitted from the light source 230 is incident on the second inclined surface 422z of the first pattern 422, totally reflected by the first inclined surface 422y of the first pattern 422, and then incident into the light guide plate 410. As a result, the light incidence efficiency of the light guide plate 410 can be improved and light leakage can be reduced.

According to an embodiment, a plurality of grooves can be formed in the base member 421 along the boundary between the first pattern 422 and the second pattern 423, i.e., the boundary between the upper surface 410a of the light guide plate 410 and the first inclined portion 410GS1_1. In other words, a plurality of grooves are formed in a region where the base member 421 folds down along the first inclined portion 410GS1_1 of the light guide plate. The plurality of grooves enable the base member 421 to be effectively folded when the base member 421 is coupled with the light guide plate 410.

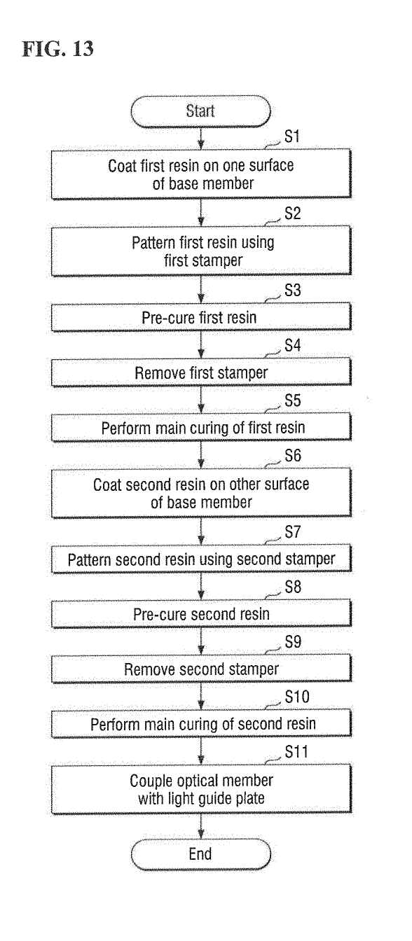

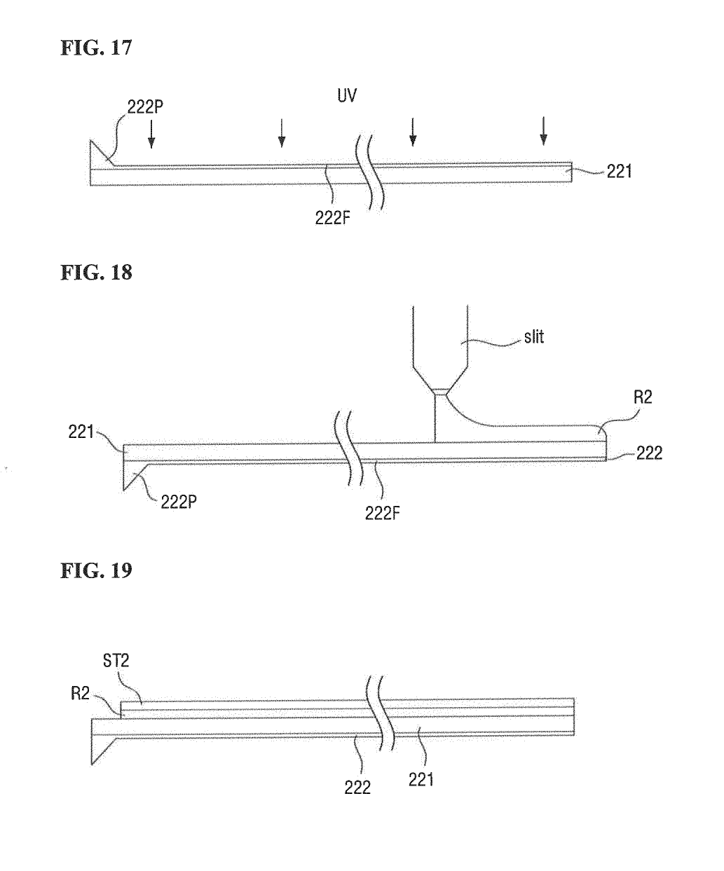

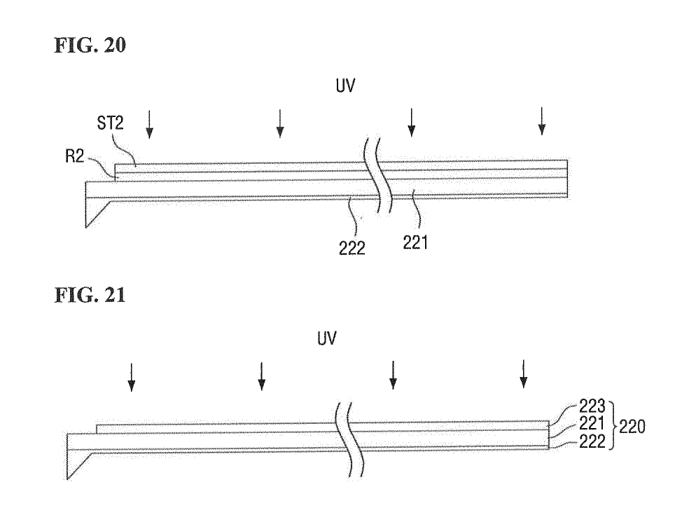

Hereinafter, a method for manufacturing a light guide plate that includes an optical member according to an embodiment of the present disclosure will be described with reference to FIGS. 13 to 22.

FIG. 13 is a flowchart of a method of manufacturing an optical member according to an embodiment of the present disclosure.

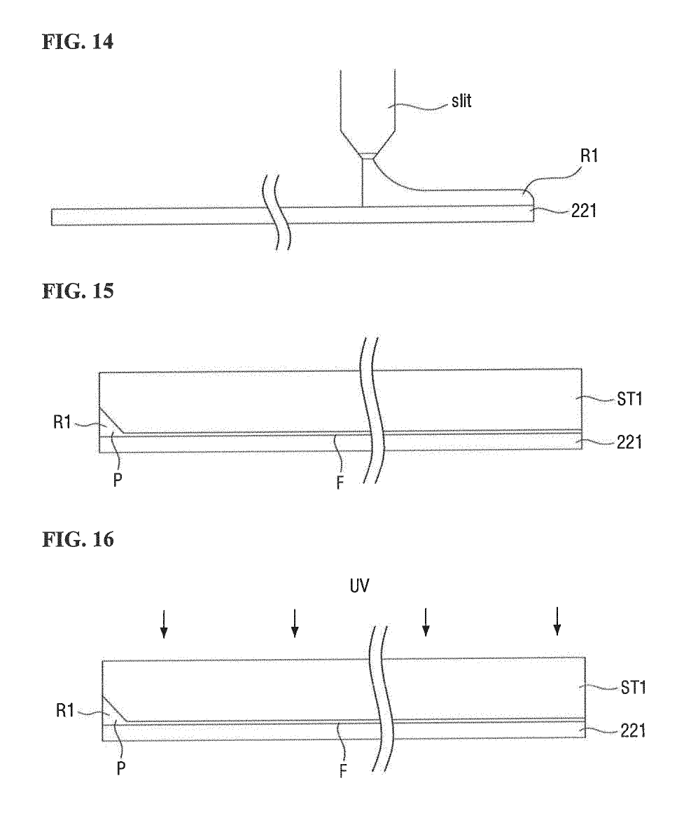

Referring to FIGS. 13 and 14, according to an embodiment, a first resin R1 is coated on one surface of a base member 221 using a slit nozzle (S1). The first resin R1 is coated on the entire surface of the base member 221.

According to an embodiment, the first resin R1 is formed of a material that includes a base resin, a UV initiator and a binder. The base resin may be formed of acrylate, urethane, urethane acrylate, silicone and epoxy or a combination thereof. However, embodiments of the present disclosure are not limited thereto as long as materials having a sufficient bonding force are coated on the base member 221.

Referring to FIGS. 13 and 15, according to an embodiment, a protruding portion P and a flat portion F are formed in the first resin R1 using a first stamper ST1 (S2). That is, a pattern of the first stamper ST1 is transferred to the first resin R1 to form a pattern which is the reverse of the pattern and the shade of the first stamper ST1.

Next, according to an embodiment, as shown in FIGS. 13 and 16, ultraviolet (UV) light is irradiated onto the first stamper ST1 to pre-cure the first resin R1 (S3), and then the first stamper ST1 is removed (S4). By performing the pre-curing step, the bonding force of the first resin R1 increases, and it is possible to prevent the first resin R1 from separating when the first stamper ST1 is removed.

Subsequently, according to an embodiment, as shown in FIGS, 13 and 17, ultraviolet (UV) light is directly irradiated onto the first resin R1 to perform main curing, thereby forming the first pattern with the protruding portion 222P and the fiat portion 222F (S5).

Referring to FIGS. 13 and 18, according to an embodiment, the second pattern 223 is formed similar to the first pattern 222. That is, by using a slit nozzle on the other surface of the base member 221, i.e., the surface opposite from the surface on which the first pattern 222 is formed, a second resin R2 is coated (S6). The second resin R2 is coated to a predetermined position from the side surface of the base member 221. That is, the second resin R2 exposes a part of the upper surface of the base member 221 on a side opposite from where the protruding portion 222P of the first pattern 222 is disposed.

Subsequently, according to an embodiment, as shown in FIGS. 13 and 19, an optical pattern is formed on the second resin R2 using a second stamper ST2 (S7). For example, a second pattern 223 is formed that includes a plurality of lenticular shapes that extend continuously in one direction.

Next, according to an embodiment, as shown in FIGS. 13, 20 and 21, ultraviolet (UV) light is irradiated onto the second stamper ST2 to pre-cure the second resin R2 (S8), after which the second stamper ST2 is removed (S9). Subsequently, ultraviolet (UV) light is directly irradiated onto the second resin R2 to perform main curing, thereby forming the second pattern 223 (S10).

As described above, according to an embodiment, the optical member 220 is manufactured by forming the first pattern 222 and the second pattern 223 on the base member 221 using an imprinting method. Although the second pattern 223 has been described above as being formed after the first pattern 222, embodiments of the present disclosure are not limited thereto. In other embodiments, the first pattern 222 is formed after the second pattern 223.

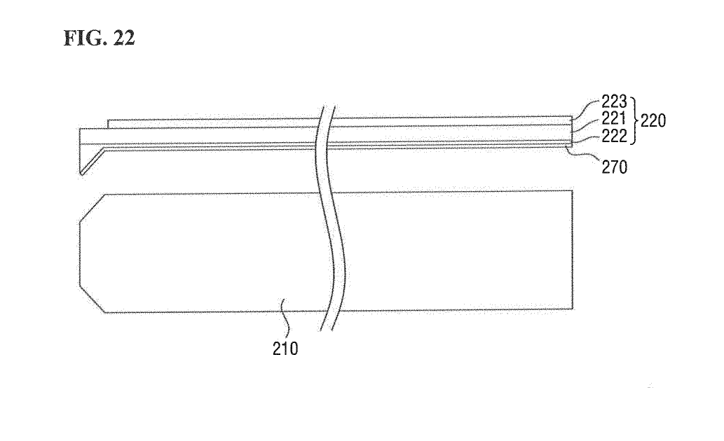

Subsequently, according to an embodiment, as shown in FIGS. 13 and 22, the optical member 220 is coupled with the light guide plate 210. Specifically, the light guide plate 210 and the optical member 220 are coupled with each other by adhesive member 270 interposed between the light guide plate 210 and the optical member 220.

As described above, according to an embodiment, the adhesive member 270 is a transparent adhesive member such as an optical transparent adhesive (OCA) or an optical transparent resin (OCR), and is formed of a material having a refractive index less than that of the light guide plate 210.

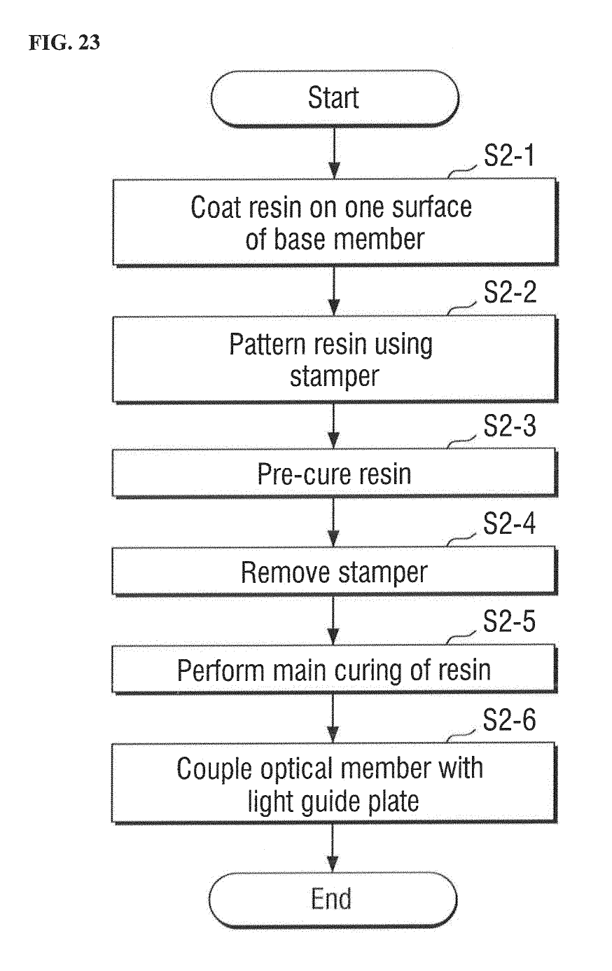

Hereinafter, a method for manufacturing a light guide plate that includes an optical member according to another embodiment of the present disclosure will be described with reference to FIGS. 23 to 26. For convenience of explanation, descriptions of the same or similar steps as those of the previously described embodiment will be omitted or simplified, and differences thereof will be mainly described.

FIG. 23 is a flowchart of a method of manufacturing an optical member according to another embodiment of the present disclosure.

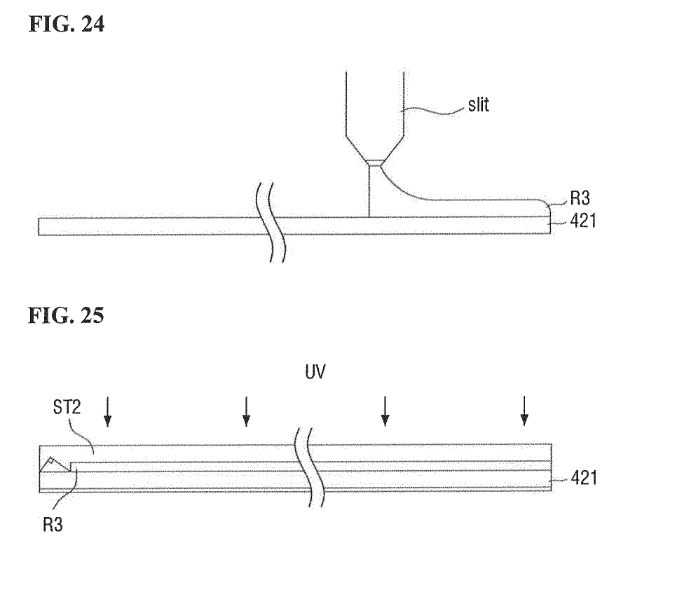

FIGS. 24 to 26 are cross-sectional views that illustrate a method of manufacturing an optical member according to another embodiment of the present disclosure.

Referring to FIGS. 23, 24 and 25, according to an embodiment, a resin R3 is coated on one surface of the base member 421 (S2-1). The resin R3 is coated on the entire surface of the base member 421. Then, a stamper ST3 is disposed on the resin R3 to pattern a shape that corresponds to the first pattern 422 and the second pattern 423 (S2-2). That is, the first pattern 422 and the second pattern 423 are formed on one surface of the base member 421 at the same time. Next, the stamper ST3 is irradiated with ultraviolet (UV) light to perform pre-curing (S2-3), after which the stamper ST3 is removed (S2-5), and ultraviolet (UV) light is irradiated directly onto the resin R3 to perform main curing to form the first pattern 422 and the second pattern 423 (S2-5).

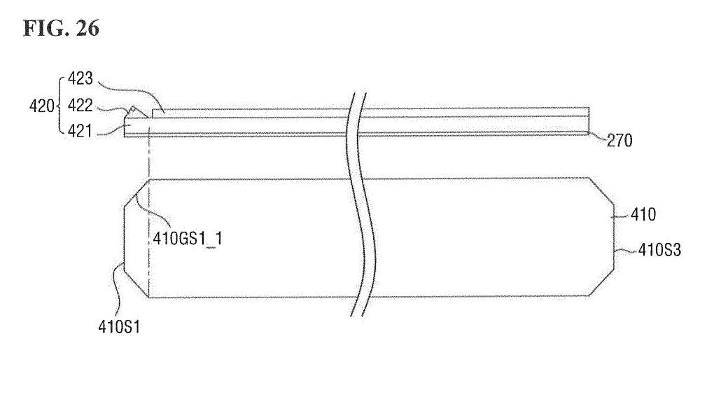

Next, according to an embodiment, as shown in FIGS. 23 and 26, the optical member 420 is coupled with the light guide plate 410 (S2-6). After the first pattern 422 is aligned with the light incidence surface 410S1 of the light guide plate 410, the optical member 420 is disposed on the light guide plate 410. The flat base member 421 is folded to be inclined downward in accordance with the inclination of the first inclined portion 410GS1_1.

As described above, according to embodiments, by forming the first pattern 422 and the second pattern 423 on one surface of the base member 421 at the same time, a manufacturing process can be simplified and the cost can be reduced.

In concluding the detailed description, those skilled in the art will appreciate that many variations and modifications can be made to exemplary embodiments without substantially departing from the principles of the present disclosure. Therefore, the disclosed exemplary embodiments of the disclosure are used in a generic and descriptive sense only and not for purposes of limitation.

What is claimed is:

1. A backlight unit comprising:
a light guide plate that includes an upper surface, at least one side surface, and an inclined portion disposed at an edge between the upper surface and the at least one side surface; and
an optical member that includes a protruding portion disposed on the inclined portion of the light guide plate.

2. The backlight unit of claim 1, wherein the protruding portion has a right-triangular prism shape that extends in a first direction parallel to a longitudinal direction of the at least one side surface, wherein a hypotenuse of a cross section of the protruding portion is aligned on the inclined portion of the light guide plate.

3. The backlight unit of claim 2, wherein the optical member further includes a flat portion that is integrally connected to the protruding portion and is disposed on the upper surface of the light guide plate,
wherein the protruding portion becomes thicker with increasing distance from the fiat portion.

4. The backlight unit of claim 3, wherein an upper surface of the protruding portion and an upper surface of the flat portion are located on the same plane.

5. The backlight unit of claim 1, further comprising an adhesive member disposed between the optical member and the light guide plate, wherein the optical member is attached to the light guide plate by the adhesive member.

6. The backlight unit of claim 5, wherein a refractive index of the adhesive member is less than a refractive index of the light guide plate.

7. The backlight unit of claim 6, wherein the refractive index of the adhesive member is in a range of about 1.2 to 1.3.

8. The backlight unit of claim 3, wherein the optical member further includes a base member, and the protruding portion and the flat portion are disposed on a lower surface of the base member.

9. The backlight unit of claim 8, wherein the optical member further includes a pattern disposed on an upper surface of the base member that extends in a second direction perpendicular to the first direction.

10. The backlight unit of claim 9, wherein one side surface of the pattern is positioned inward from the at least one side surface of the light guide plate.

11. The backlight unit of claim 10, wherein the pattern includes a plurality of prisms or lenticular shapes that extend in the second direction.

12. The backlight unit of claim 2, further comprising a light source disposed adjacent to the one side surface.

13. The backlight unit of claim 2, wherein the optical member further includes a base member and a pattern that extends in a second direction perpendicular to the first direction, wherein the protruding portion and the pattern are disposed on an upper surface of the base member.

14. The backlight unit of claim 13, wherein the base member includes at least one groove aligned with a boundary between the upper surface and the protruding portion.

15. The backlight unit of claim 2, wherein a side surface of the protruding portion is parallel to the at least one side surface of the light guide plate.

16. The backlight unit of claim 15, wherein the side surface of the protruding portion is aligned with the at least one side surface of the light guide plate.

17. The backlight unit of claim 2, wherein a cross section of the protruding portion is a right-angled triangle in which an inclination angle of a hypotenuse is equal to an inclination angle of the inclined portion.

18. An optical member comprising:
a base member;
a first pattern disposed on a first surface of the base member; and
a second pattern disposed on second surface of the base member that is opposite to the first surface,
wherein the first pattern includes a protruding portion disposed adjacent to a side surface of the base member,
wherein a thickness of the protruding portion is greater than or equal to the thickness of the flat portion,
wherein the protruding portion has a triangular prism shape that extends in a first direction parallel to the side surface,
wherein a cross section of the protruding portion becomes thinner with increasing distance from the side surface, and
wherein the second pattern includes a plurality of prisms or lenticular shapes that extend in a second direction perpendicular to the first direction

19. An optical member comprising;
a base member;
a first pattern disposed on a surface of the base member; and
a second pattern disposed adjacent to the first pattern on the surface of the base member, wherein the first pattern includes a protruding portion disposed adjacent to a side surface of the base member,
wherein the protruding portion has a triangular prism shape that extends in a first direction parallel to the side surface,
wherein the second pattern includes a plurality of prisms or lenticular shapes that extend in a second direction perpendicular to the first direction, and
wherein an area of the second pattern is larger than an area of the first pattern in a plan view.

20. The optical member of claim 19, wherein the base member includes at least one groove at a boundary between the first pattern and the second pattern.
